(19) United States
(12) Patent Application Publication
(10) Pub. No.: US 2007/0226223 A1
(43) Pub. Date: Sep. 27, 2007

(54) METHOD AND APPARATUS FOR LOADING OF INFORMATION TO A PORTABLE DEVICE

(75) Inventor: Brett L. Lindsley, Wheaton, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg (US)

(21) Appl. No.: 11/276,613

(22) Filed: Mar. 8, 2006

(51) Int. Cl. G06F 17/30; H02J 7/00

(52) U.S. Cl. 707/10

(57) ABSTRACT

An information object from a server is loaded onto a portable device by transmitting metadata associated with the information object from the portable device to a load point device, transferring the information object from the server to the load point device in accordance with the metadata and, at a later time when the portable device may be linked with the load point device, transferring the information object from the load point device to the portable device.

### CROSS REFERENCE TO RELATED APPLICATIONS

This application is related to U.S. application No. 11/188317 filed Jul. 25, 2005 and titled “Method and Apparatus for Providing Protected Digital Content”, which is hereby incorporated herein by reference.

### BACKGROUND

Portable devices, such as cellular telephones, personal digital assistants, portable computers, digital media players for example, are used to store ever increasing amounts of information. Memory capacities of portable devices are increasing rapidly. However, the capacity to load information onto portable devices is not increasing at a corresponding rate. Wide area wireless networks used by portable devices have lower bandwidths than corresponding wired or wireless local networks or wired links. In addition, portable devices have limited battery life, so time is not available to load large amounts of data when the device is operating in a portable mode.

When a user of portable device views information, such as videos or web pages for example, rendered on the portable device, the information may reference other information that can be downloaded. There may be too much information for the portable device to download while operating in a portable mode.

One approach to this problem is for the user of the portable device to record the information for future loading onto the portable device. However, this may not always be convenient. In addition, it is difficult to record the context in which the information was displayed (for example, the currently and previously displayed websites). Further, when the user downloads the information at future time, the user will still have to wait for the information to be retrieved from a server over a network.

Another approach to loading content onto a portable is to use a load point device, such as a personal computer. The user first loads the content onto the load point device and then transfers the content to the portable device. A major disadvantage of this approach is that the information cannot be selected from a remote location using the portable device.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIGS. 1 and 2 are block diagrams of a system for loading information onto a portable device in accordance with the prior art.

FIGS. 3, 4 and 5 are block diagrams of a system, consistent with certain embodiments of the present invention, for loading information onto a portable device.

FIG. 6 is a timing chart of a process for loading an information object onto a portable device consistent with certain embodiments of the present invention.

FIG. 7 is a flow chart of a method consistent with certain embodiments of the present invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

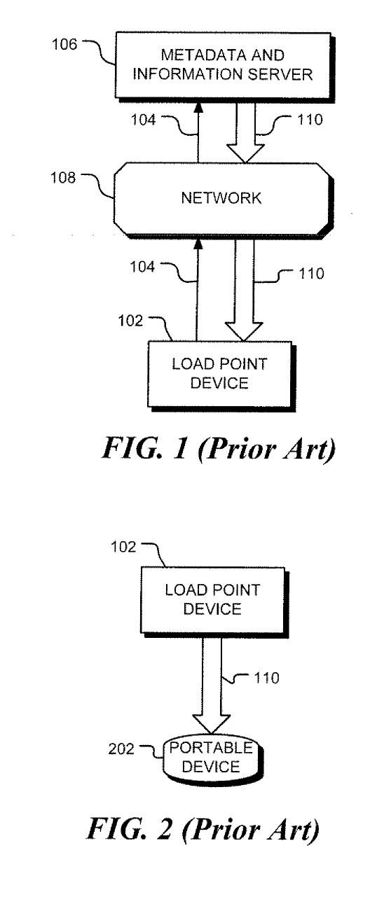

FIG. 1 and FIG. 2 are block diagrams of a system for loading information onto a portable device, such as a digital media player, in accordance with the prior art. Referring to FIG. 1, a load point device 102, such as home computer, sends an information request 104 to a server 106 via a network 108 (such as the Internet, for example). The requested information 110 is downloaded to the load point device 102 via the network 108 and is stored in the load point device. At a later time, as depicted in FIG. 2, the requested information 110 is transferred from the load point device 102 to a portable electronic device 202. This approach is used, for example, when audio or video content is downloaded from the Internet onto a portable media player. This prior art is exemplary of ‘podcasting’ wherein the information 110 consists of both metadata describing what content is available and the associated content. This approach has the disadvantage that the information cannot be requested from the portable device or from a remote location.

In further prior art approach, information is downloaded directly to the portable device 202 from the server 106 via the network 108. This approach works well for small amounts of information, but is less successful for large amounts of information due to the unreliability, cost and limited bandwidth of the network link to the portable device and limited battery life of the portable device. In particular, the storage capacity of portable devices is increasing at a faster rate than communication bandwidth.

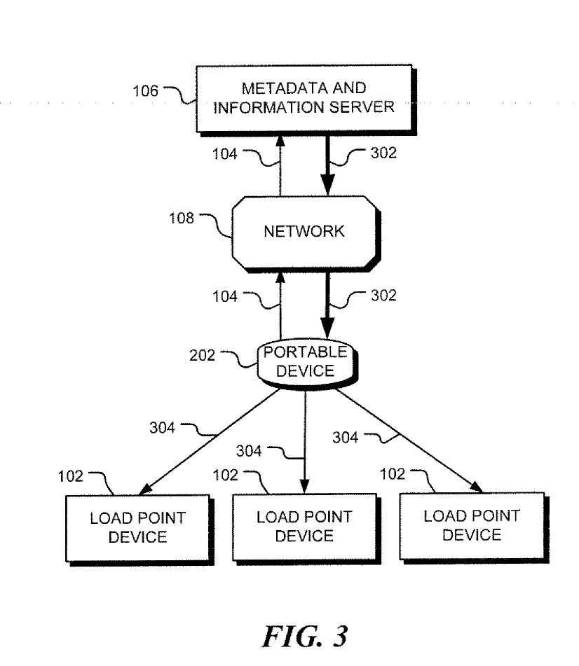

FIG. 3 is a block diagram of a system, consistent with certain embodiments of the present invention, for loading information onto a portable device. FIG. 3 depicts operation of the system in a first step. Referring to FIG. 3, a portable device 202, such as a cellular telephone handset, digital media player or handheld computer, initiates the process by sending an information request 104 to a server 106 via a network 108. The server responds by sending information 302 to the portable device 202 via the network 108. The information 302 may, for example, be a webpage or a video to be viewed on the portable device. In accordance with one embodiment, the information 302 may be a subset of the full information that contains links or other metadata that identifies the full information. Alternatively, the information 302 may contain links or other metadata relating to associated information objects. For example MPEG4 and SMIL formats have a capacity to include links to related information. Other content, such as MP3 digital audio, may contain metadata in a header. This metadata can be used to display a menu of related information on the portable device. Alternatively, the information may have been previously transferred to the portable device via a direct link or a local area network.

If a user of the portable device 202 wishes to access the associated information object, rather than requesting the information object from the server, the user may cause the portable device 202 to transmit metadata 304 to one or more load point devices 102. A load point device is a device (such as personal computer or television set top box) at a location where the user will bring the portable device to load the information object. The load point device is selected by the user and may be at a location remote from the user. For example, the load point device could be a home computer or an office computer. Multiple load point devices may be selected. The user may select different load point devices for different information objects.

Metadata is data that describes an information object (which itself is data). Metadata may include, for example, the location, content, context and structure of the information object. For example, when hypertext document is downloaded via the Internet to a portable device and viewed using a browser, the metadata may include the URL of a link (the location of the information object), a description (such as the URL or title) of the hypertext document being viewed (the context of the information document) and an identifier of the portable device (more context of the information object). The structure and content of the information object may be included implicitly via the file extension and filename in the URL link of the information object.

It will be apparent to those of ordinary skill in the art that any object-based protocol may be used over any transport to transfer the metadata from the portable device to the load point device. Object protocols include XMPP, HTTP and OBEX. For example, the metadata may be sent as an event over an XMPP instant messaging server to the load point device. This approach may be useful if the load point device is behind a firewall (which is common). Another way to send the metadata is to upload the metadata to a syndication server and have the load point device occasionally poll the syndication server for the content to load. This approach also works for load points behind firewalls, but uses an external server. If the load point is not behind a firewall, then an HTTP POST operation over any IP network (such as a WAN or LAN) could be used. When in a local environment, another way to send the metadata is to use a Bluetooth object push (OBEX over Bluetooth), or simply to synchronize the metadata back to the load point using USB (OBEX/SyncML over USB). In all of these approaches the metadata is transferred to the load point device.

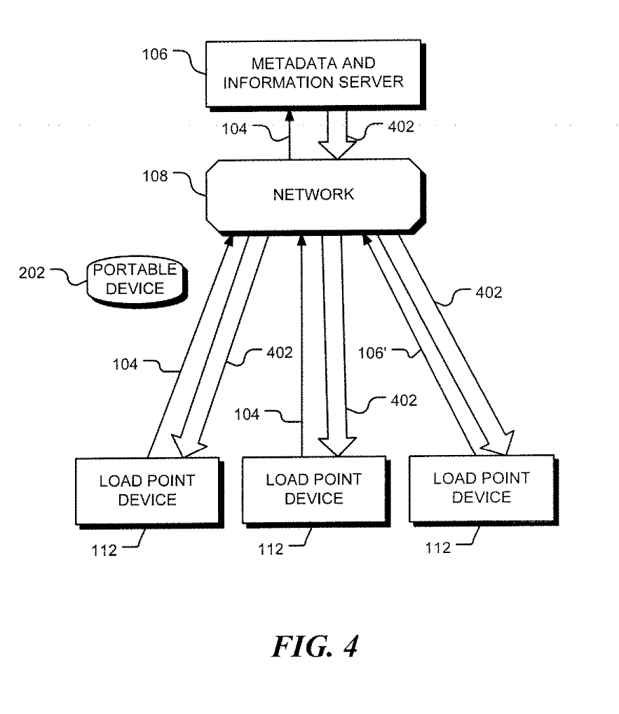

FIG. 4 is a further block diagram of a system consistent with certain embodiments of the present invention. FIG. 4 depicts operation of the system in a second step. Once the load point device has obtained the metadata, the load point device can begin loading the information object (the content). In one embodiment, the load point device first authenticates the metadata by verifying that it was sent by an authorized user. Referring to FIG. 4, a load point device 102 send an information request 104 to the server 106 via the network 108. The information request 104 includes a request for an information object specified by metadata received from a portable device. In response to the information request 104, the server 106 sends the requested information object 402 to the load point device 102 via the network 108. The information 402 object is then stored on the load point device 102.

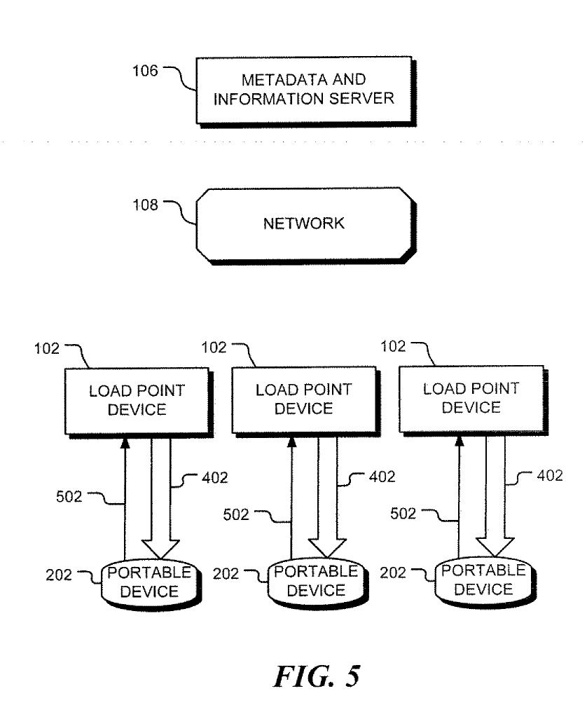

FIG. 5 is a further block diagram of a system consistent with certain embodiments of the present invention. FIG. 5 depicts operation of the system in a third step. Referring to FIG. 5, once the portable device 202 arrives at a load point device (or a location where it can connect to a load point device via a local network for example) the portable device sends a synchronization request 502 to the load point device 102. The synchronization request 502 may identify one or more information objects to be loaded onto the portable, or it may identify the portable device. In response to the synchronization request, the load point device 102 transmits one or more information objects 402 to the portable device 202. The link between the portable device 202 and the load point device 102 may be wired or wireless. Preferably, the link should have a high bandwidth and be reliable compared to the link between the portable device and the server. This allows the information object to be loaded more efficiently. In addition, the portable device may be placed in a charging station or connected to a power supply while the information is transferred.

In prior approaches, such as “podcasting”, information is selected from the load point device, rather than from the portable device and cannot be selected remotely.

Each load point device may transfer different information to the portable device, depending on what it was requested to load. The transfer may be subject to a security model. For example, each load point device may be authentication bonded with the portable device (or other portable device if transitive trust is used). The authentication bonding allows the load point device to ensure that the request to load content was received from a trusted device. Likewise, the portable device can validate the content signature before loading the information to ensure that the information is what was requested. Such security models are well known to those of ordinary skill in the art.

Once the information is loaded, the portable device can again be used in a portable mode of operation. The process can then begin again, with the user requesting more information associated with the downloaded information. Thus, the process is cyclic.

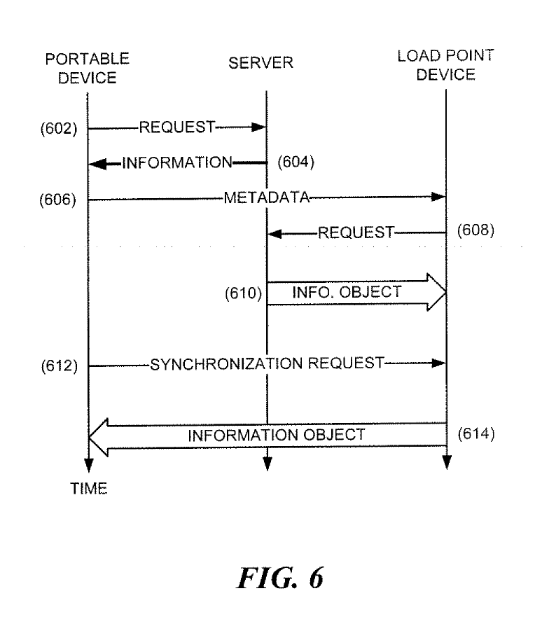

FIG. 6 is a timing chart of a process for loading an information object onto a portable device. Referring to FIG. 6, the process begins at time (602) when an information request is sent from the portable device to a server via a network. The server responds at time (604) by sending the requested information to the portable device. If the user of the portable device wishes to retrieve an information object identified in the requested information (by a URL link, for example), the user instructs the portable device to send metadata to one or more load point devices at time (606). The metadata identifies the information object and may additionally include other data such as the context in which the information object was requested and an identifier of the portable device or user. In a further embodiment, the information is preloaded on the portable device. If the user of the portable device wishes to retrieve an information object identified in the preloaded information (by a URL link, for example), the user instructs the portable device to send metadata to one or more load point devices at time (606). At time (608), the load point device sends a request (via the network) to the server for the information object identified in the metadata. At time (610) the server sends the requested information object to the load point device. At time (612), when the portable device is in a location where it can link with the load point device, the portable device sends a synchronization request to the load point device. The load point device responds by transmitting the information object to the portable device at time (614). The load point device and the portable device may use a synchronization algorithm, such that only information not already on the portable device is transmitted.

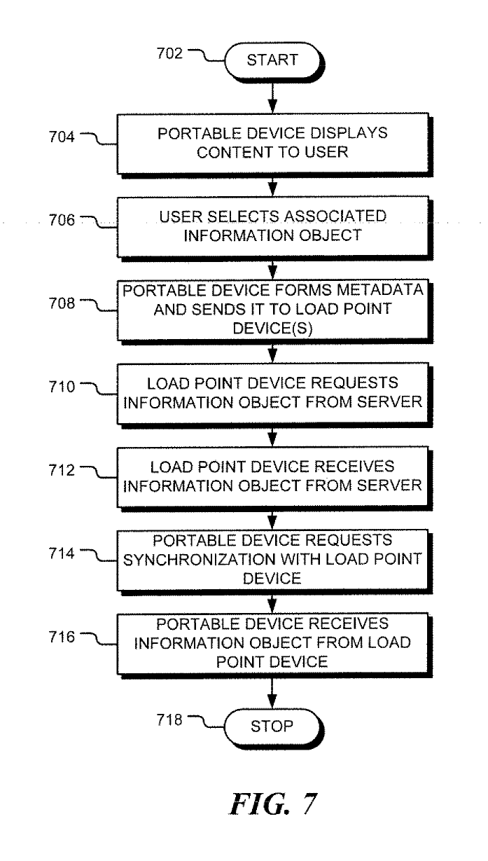

FIG. 7 is a flow chart of a method consistent with certain embodiments of the present invention. Following start block 702 the portable device displays content to a user at block 704. At block 706, the user selects an information object associated with the displayed content. The associated information object may be identified in the displayed content by a URL link, header information displayed in menu, or some other means. The portable device forms metadata corresponding to the information object and sends metadata to one or more load point devices at block 708. The metadata identifies the information object and may additionally include other data such as the context in which the information object was requested or an identifier of the portable device or user. If the information is already loaded on the portable device, the process may begin at block 708. At block 710, the load point device sends a request (via the network) to the server for the information object identified in the metadata. At block 712 the server sends the requested information object to the load point device. At block 714, the portable device sends a synchronization request to the load point device. The portable device receives the information object from the load point device at block 716 and the process terminates at block 718. The information object is now stored on the portable device. The portable device may be remote from the load point device when the metadata is sent.

The metadata may be sent from the portable device using a push protocol in which the portable device opens a connection with the load point device and then sends the metadata. Alternatively, the metadata may be stored in the portable device or on an intermediate server and then periodically retrieved by the load point device using a pull protocol.

It will be apparent to those of ordinary skill in the art that various type of information objects may be loaded in the manner described above. For example, the load point device may retrieve both non-rights-protected content and right-protected, encrypted content from the server.

The network connection between the load point device and the server may be a wide-area network.

Metadata may be sent from the portable device to the load point via a local network.

The metadata may include instructions to load a specific information object, plus any objects that are associated with the specific information object. Since information objects are often linked in a hierarchical tree structure, the instructions may specify how many levels of the hierarchy are to be loaded.

The present invention, as described in embodiments herein, is implemented using a programmed processor executing programming instructions that are broadly described above in flow chart form that can be stored on any suitable electronic storage medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method for loading an information object from a server onto a portable device, the method comprising:
transmitting metadata associated with the information object from the portable device to a load point device;
transferring the information object from the server to the load point device in accordance with the metadata; and
transferring the information object from the load point device to the portable device.

2. A method in accordance with claim 1, wherein the information object is selected from at least one information object identifier displayed on the portable device.

3. A method in accordance with claim 1, wherein the information object is associated with content displayed on the portable device.

4. A method in accordance with claim 1, wherein transmitting metadata of the information object from the portable device to the load point device comprises transmitting the metadata using a push transport protocol.

5. A method in accordance with claim 1, wherein transmitting metadata of the information object from the portable device to the load point device comprises transmitting the metadata using a pull transport protocol.

6. A method in accordance with claim 1, wherein transmitting metadata of the information object from the portable device to the load point device comprises transmitting the metadata via a wide-area network.

7. A method in accordance with claim 1, wherein transmitting metadata of the information object from the portable device to the load point device comprises transmitting the metadata via a local-area network.

8. A method in accordance with claim 1, wherein the information object is rights-protected and encrypted.

9. A method in accordance with claim 1, wherein transferring the information object from the load point device to the portable device comprises synchronizing information stored on the portable device with information stored on the load point device.

10. A method in accordance with claim 1, wherein transferring the information object from the load point device to the portable device comprises the load point device authenticating the portable device.

11. A method in accordance with claim 1, further comprising transmitting the metadata to at least one additional load point device.

12. A computer readable medium comprising program instructions that, when executed by a portable device:
select an identifier of an information object in response to a user input to the portable device;
form metadata related to the information object;
transmit the metadata to a remote load point device; and
transfer the information object to the portable device from the load point device when the portable device is linked to the load point device, wherein the metadata requests the load point device to load the information object from a network server.

13. A computer readable medium in accordance with claim 12, wherein the program instructions to transfer the information object to the portable device from the load point device comprises program instructions to synchronize information objects stored on the portable device with information objects stored on the load point device.

14. A portable device comprising elements operable to:
select an identifier of an information object in response to a user input to the portable device;
form metadata associated with the information object;
transmit the metadata to a load point device at a location remote from the portable device; and
download the information object to the portable device from the load point device when the portable device is linked to the load point device, wherein the metadata comprises information to allow the load point device to load the information object from a network server onto the load point device.

15. A portable device in accordance with claim 14, further operable to verify that an information object on the load point device corresponds to the information object associated with the metadata.

16. A portable device in accordance with claim 14, further operable to download from the load point device only those information objects that are not already stored on the portable device.

17. A load point device comprising elements operable to:
receive metadata associated with an information object from a portable device at a location remote from the load point device;
load the information object from a network server in accordance with the metadata; and
transfer the information object to the portable device from the load point device when the portable device is in proximity to the load point device.

18. A load point device in accordance with claim 16, further operable to verify that the portable device is authorized to receive the information object.

19. A load point device in accordance with claim 16, further operable to transfer only those information objects that are not already stored on the portable device.

20. A load point device in accordance with claim 16, wherein the load point device is operable to receive metadata associated with an information object from a portable device at a location remote from the load point device by polling an intermediate server that receives the metadata from the portable device.
